(19) United States
(12) Patent Application Publication
(10) Pub. No.: US 2021/0132175 A1
(43) Pub. Date: May 6, 2021

(54) ON-BOARD DEVICE, VEHICLE COMMUNICATION SYSTEM, AND DIRECTION-OF-ARRIVAL ESTIMATION METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi (JP)

(72) Inventor: Kenji Matsuoka, Yokkaichi, Mie (JP)

(21) Appl. No.: 16/617,037

(22) PCT Filed: May 29, 2018
(86) PCT No.: PCT/JP2018/020449

§ 371 Date: Nov. 26, 2019

(30) Foreign Application Priority Data
Jun. 19, 2017 (JP) 2017-119775

(51) Int. Cl. G01S 3/48; H01Q 1/32; H01Q 3/36; B60R 25/24; B60R 25/30

(52) U.S. Cl. CPC G01S 3/48; H01Q 1/3241; B60R 25/30; B60R 25/24; H01Q 3/36

(57) ABSTRACT

An on-board device, a vehicle communication system, and a direction-of-arrival estimation method are provided. An on-board device transmits signals from a plurality of transmission antennas that are provided for a vehicle at positions that are separate from each other, and performs processing corresponding to a response signal from a portable device that has received the signals. The on-board device includes: a reception unit that receives the response signal via a plurality of reception antennas that are provided for the vehicle at positions that are separate from each other; and an estimation unit that estimates a direction of arrival of the response signal based on a phase difference of the response signal received via the plurality of reception antennas.

### CROSS-REFERENCE TO RELATED APPLICATIONS

This application is the U.S. national stage of PCT/JP2018/020449 filed on May 29, 2018, which claims priority of Japanese Patent Application No. JP 2017-119775 filed on Jun. 19, 2017, the contents of which are incorporated herein.

### TECHNICAL FIELD

The present disclosure relates to an on-board device, a vehicle communication system, and a direction-of-arrival estimation method.

### BACKGROUND

Vehicle communication systems that lock and unlock a vehicle door without using a mechanical key have come into practical use. Specifically, a keyless entry system, which allows a user to lock or unlock a vehicle door by performing a wireless remote operation using a portable device that belongs to the user, and a Smart Entry (registered trademark) system, which allows a user who owns the portable device to unlock a vehicle door by approaching the vehicle or holding a door handle, have come into practical use, for example.

In addition, a vehicle communication system that starts the engine of a vehicle without using a mechanical key has been put into practice. Specifically, a push-start system, which allows a user who owns a portable device, to start the engine upon the user simply pressing an engine start button, has been put into practice.

Furthermore, a welcome light system, which lights up an internal vehicle light or an external vehicle light when a user who owns a portable device approaches the vehicle, has come into practical use.

In such a vehicle communication system, the on-board device performs wireless communication with the portable device. The wireless communication is realized by: the on-board device transmitting various kinds of signals from transmission antennas thereof to the portable device, using radio waves in an LF (Low Frequency) band; and the portable device thus receiving the signals and transmitting a response signal, using radio waves in a UHF (Ultra High Frequency) band. Upon performing authorization and checking the position of the portable device, the on-board device performs control to unlock a door, lock a door, start the engine, turn on a welcome light, and so on.

Here, signals transmitted from the on-board device are in the LF band, and the transmission range of the signals is limited to a predetermined range in the vicinity of the vehicle. In order to detect the position of the portable device with high accuracy, or swiftly detect the portable device approaching the vehicle, the signal reception sensitivity of the portable device may be set to be high. However, such a setting shortens the lifespan of the battery that drives the portable device.

JP 2015-113644A discloses technology for setting the reception sensitivity of the portable device to high sensitivity upon determining that the portable device is present in the cabin of the vehicle or at a distance that is no longer than a predetermined distance from the vehicle, and setting the reception sensitivity of the portable device to low sensitivity upon determining that the portable device is not present in the cabin of the vehicle nor at a distance that is no longer than the predetermined distance from the vehicle.

### DISCLOSURE

However, according to JP 2015-113644A, the reception sensitivity of the portable device remains low until the portable device approaches the vehicle. Therefore, it is not possible to swiftly detect the portable device approaching the vehicle. In addition, if it is erroneously determined that the portable device is not present at a distance that is no longer than the predetermined distance from the vehicle, there is a problem in which it is difficult to detect the position of the portable device because the reception sensitivity of the portable device is in a low sensitivity state.

An objective of the present disclosure is to provide an on-board device, a vehicle communication system, and a direction-of-arrival estimation method that can expand the transmission range of signals that are transmitted from transmission antennas of the on-board device, and can estimate the direction of arrival of a response signal that is transmitted from a portable device.

### SUMMARY

An on-board device according to one aspect of the present disclosure is an on-board device that transmits signals from a plurality of transmission antennas that are provided for a vehicle at positions that are separate from each other, and performs processing corresponding to a response signal from a portable device that has received the signals, the on-board device including: a reception unit that receives the response signal via a plurality of reception antennas that are provided for the vehicle at positions that are separate from each other; and an estimation unit that estimates a direction of arrival of the response signal based on a phase difference of the response signal received via the plurality of reception antennas.

A vehicle communication system according to one aspect of the present disclosure includes: the above-described on-board device; a plurality of transmission antennas that are provided for a vehicle at positions that are separate from each other; a portable device that receives the signals transmitted from the on-board device, and transmits a response signal corresponding to the signals thus received; and a plurality of reception antennas that are provided for the vehicle at positions that are separate from each other, and individually receive the response signal from the portable device.

A direction-of-arrival estimation method according to one aspect of the present disclosure is a direction-of-arrival estimation method for estimating a direction of arrival of a response signal based on the response signal, the response signal being transmitted from a portable device that has received signals transmitted from a plurality of transmission antennas provided for a vehicle at positions separate from each other, the direction-of-arrival estimation method including: receiving the response signal via a plurality of reception antennas that are provided for the vehicle at positions that are separate from each other; and estimating the direction of arrival of the response signal based on a phase difference of the response signal received via the plurality of reception antennas.

Note that the present application is realized not only as an on-board device that includes the characteristic processing unit and transmission unit, but also as a signal transmission method that includes steps of such characteristic processing, or a program for causing a computer to execute such steps, for example. Also, the present application may be realized as a semiconductor integrated circuit that realizes part or all of the on-board device, or another system that includes the on-board device, for example.

### Advantageous Effects

As described above, it is possible to expand the transmission ranges of signals transmitted from transmission antennas of an on-board device, and estimate the direction of arrival of a response signal transmitted from a portable device.

### BRIEF DESCRIPTION OF DRAWINGS

FIG. 1 is a schematic diagram illustrating an example of a configuration of a vehicle communication system according to a first embodiment.

FIG. 2 is a block diagram showing an example of a configuration of an on-board device 1.

FIG. 3A is a diagram illustrating transmission ranges in a case where signals are individually transmitted from LF transmission antennas.

FIG. 3B is a diagram illustrating transmission ranges in a case where signals are individually transmitted from the LF transmission antennas.

FIG. 4A is a diagram illustrating transmission ranges in a case where signals are substantially simultaneously transmitted from two LF transmission antennas.

FIG. 4B is a diagram illustrating transmission ranges in a case where signals are substantially simultaneously transmitted from two LF transmission antennas.

FIG. 5 is a block diagram showing an example of a configuration of a detection device.

FIG. 6 is a block diagram showing an example of a configuration of a portable device.

FIG. 7 is a flowchart showing processing procedures that are performed by the on-board device and the portable device.

FIG. 8 is a block diagram illustrating an example of a configuration of an on-board transmission unit according to a second embodiment.

FIG. 9 is a distribution diagram showing an example of a magnetic field distribution of signal waves that are transmitted from LF transmission antennas.

### DETAILED DESCRIPTION OF PREFERRED EMBODIMENTS

Embodiments of the present disclosure will be listed and described. At least some of the embodiments described below may be combined as appropriate.

An on-board device according to one aspect of the present disclosure is an on-board device that transmits signals from a plurality of transmission antennas that are provided for a vehicle at positions that are separate from each other, and performs processing corresponding to a response signal from a portable device that has received the signals, the on-board device including: a reception unit that receives the response signal via a plurality of reception antennas that are provided for the vehicle at positions that are separate from each other; and an estimation unit that estimates a direction of arrival of the response signal based on a phase difference of the response signal received via the plurality of reception antennas.

According to this aspect, the on-board device receives a response signal from a portable device via a plurality of reception antennas, and estimates the direction of arrival of the response signal based on the phase difference of the response signal thus received. Also, using the result of estimation, it is possible to detect the position and the moving direction of the portable device from which the response signal has been transmitted.

In the on-board device according to one aspect of the present disclosure, signals in an LF band are transmitted from the plurality of transmission antennas.

According to this aspect, the signals that are substantially simultaneously transmitted from the transmission antennas are signals in the LF band, and the amplitudes of the signals around the vehicle are uniform. Therefore, in areas where the magnetic fields of the signal waves respectively transmitted from the transmission antennas are orientated in the same direction, the signals do not interfere with or weaken each other, and the signal strength increases due to the signals being simply superimposed on each other.

In the on-board device according to one aspect of the present disclosure, at least two transmission antennas of the plurality of transmission antennas are located at positions that are separate from each other in a front-rear direction or a left-right direction relative to a travelling direction of the vehicle, and the signals are substantially simultaneously transmitted from the two transmission antennas located at the positions that are separate from each other in the front-rear direction or the left-right direction.

According to this aspect, if signals are substantially simultaneously transmitted from two transmission antennas located at positions that are separate from each other in the front-rear direction relative to the travelling direction of the vehicle, the transmission range of the signals expands in the left-right direction of the vehicle, for example. Similarly, if signals are substantially simultaneously transmitted from two transmission antennas located at positions that are separate from each other in the left-right direction relative to the travelling direction of the vehicle, the transmission range of the signals expands in the front-rear direction of the vehicle, for example. Note that, if signals are substantially simultaneously transmitted from a plurality of transmission antennas that are located at front, rear, left, and right positions relative to the travelling direction of the vehicle, the transmission range of the signals expands in the front-rear direction and the left-right direction of the vehicle.

The on-board device according to one aspect of the present disclosure includes a phase control unit that controls phases of the signals that are substantially simultaneously transmitted from the two transmission antennas.

According to this aspect, it is possible to control the direction in which the transmission range of the signals are expanded, by controlling the phases of the signals that are substantially simultaneously transmitted.

In the on-board device according to one aspect of the present disclosure, a signal for activating the portable device is transmitted via the plurality of transmission antennas.

According to this aspect, it is possible to expand the transmission range of signals that are used to activate the portable device. Therefore, it is possible to activate the portable device that is more distant from the vehicle.

In the on-board device according to one aspect of the present disclosure, the plurality of transmission antennas are respectively located at tire positions at which a plurality of tires of the vehicle are provided, and signals are transmitted from the transmission antennas provided at the tire positions, to a plurality of detection devices that are respectively provided for the plurality of tires and wirelessly transmit air pressure signals obtained by detecting air pressures of the tires.

According to this aspect, the on-board device can communicate with the detection device that detects the air pressure in the tires, using the plurality of transmission antennas, and can also communicate with the portable device, using the transmission antennas.

A vehicle communication system according to one aspect of the present disclosure includes: the above-described on-board device; a plurality of transmission antennas that are provided for a vehicle at positions that are separate from each other; a portable device that receives the signals transmitted from the on-board device, and transmits a response signal corresponding to the signals thus received; and a plurality of reception antennas that are provided for the vehicle at positions that are separate from each other, and individually receive the response signal from the portable device.

According to this aspect, it is possible to expand the transmission range of the signals transmitted from the transmission antennas of the on-board device. Therefore, the on-board device can wirelessly communicate with the portable device that is more distant, and can execute processing corresponding to the results of wireless communication.

A direction-of-arrival estimation method according to one aspect of the present disclosure is a direction-of-arrival estimation method for estimating a direction of arrival of a response signal based on the response signal, the response signal being transmitted from a portable device that has received signals transmitted from a plurality of transmission antennas provided for a vehicle at positions separate from each other, the direction-of-arrival estimation method including: receiving the response signal via a plurality of reception antennas that are provided for the vehicle at positions that are separate from each other; and estimating the direction of arrival of the response signal based on a phase difference of the response signal received via the plurality of reception antennas.

According to this aspect, the on-board device receives a response signal from a portable device via a plurality of reception antennas, and estimates the direction of arrival of the response signal based on the phase difference of the response signal thus received. Also, using the result of estimation, it is possible to detect the position and the moving direction of the portable device from which the response signal has been transmitted.

The following specifically describes the present disclosure with reference to drawings that show embodiments of thereof.

### First Embodiment

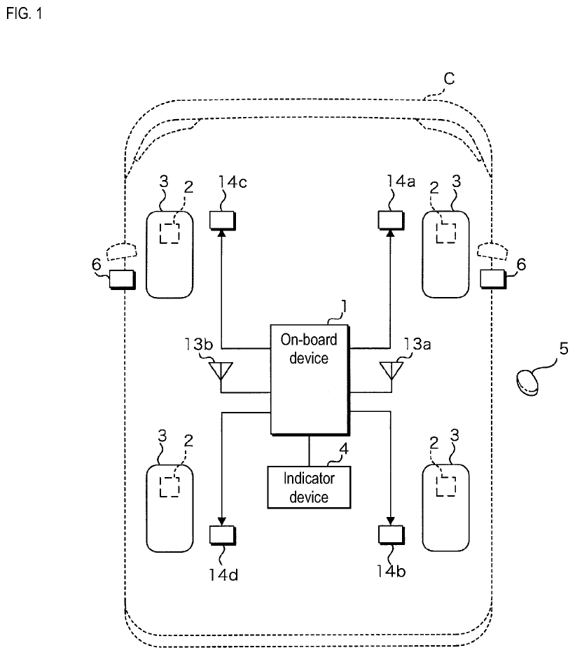

FIG. 1 is a schematic diagram illustrating an example of a configuration of a vehicle communication system according to a first embodiment. The vehicle communication system according to the present embodiment includes an on-board device 1 that is provided at an appropriate position of a vehicle body, a plurality of detection devices 2 that are respectively provided for the wheels of a plurality of tires 3 that are provided for a vehicle C, an indicator device 4, a portable device 5, and external vehicle illumination units 6, and constitutes a tire pressure monitoring system and a welcome light system.

A first LF transmission antenna 14a, a second LF transmission antenna 14b, a third LF transmission antenna 14c, and a fourth LF transmission antenna 14d are connected to the on-board device 1. The first to fourth LF transmission antennas 14a, 14b, 14c, and 14d are, for example, separately located at right-front, right-rear, left-front, and left-rear tire positions of the vehicle C, to which the four tires 3 are attached. The tire positions are positions corresponding to the wheel wells and the surroundings thereof, and at which the detection devices 2 provided for the tires 3 can individually receive signals respectively transmitted from the first to fourth LF transmission antennas 14a, 14b, 14c, and 14d.

Note that, in the following description, when the first to fourth LF transmission antennas 14a, 14b, 14c, and 14d need not be distinguished from each other, the first to fourth LF transmission antennas 14a, 14b, 14c, and 14d may be simply referred to as LF transmission antennas.

In the vehicle communication system, when serving as a tire pressure monitoring system, the on-board device 1 transmits air pressure information request signals, which request information regarding the air pressure in the tires 3, to the detection devices 2, respectively from the first to fourth LF transmission antennas 14a, 14b, 14c, and 14d, using radio waves in the LF band. The detection devices 2 detect the air pressure in the tires 3 in response to the air pressure information request signals, and wirelessly transmit air pressure signals, which include the air pressure information thus detected and acquired and sensor identifiers of the detection devices 2, to the on-board device 1, using radio waves in the UHF band. The on-board device 1 is provided with RF reception antennas 13a and 13b that are located separate from each other. Using the RF reception antennas 13a and 13b, the on-board device 1 receives air pressure signals transmitted from the detection devices 2, and acquires air pressure information regarding the tires 3 from the air pressure signals. The indicator device 4 is connected to the on-board device 1 via a communication line, and the on-board device 1 transmits the acquired air pressure information to the indicator device 4. The indicator device 4 receives the air pressure information transmitted from the on-board device 1, and indicates the air pressure information regarding each of the tires 3. Also, if the air pressure in a tire 3 is lower than a predetermined threshold, the indicator device 4 issues a warning.

On the other hand, in the vehicle communication system, when serving as a welcome light system, the on-board device 1 transmits signals (position detection signals) that are used to detect the portable device 5 that is located in the vicinity of the vehicle C, to the portable device 5, respectively from the first to fourth LF transmission antennas 14a, 14b, 14c, and 14d, using radio waves in the LF band. The portable device 5 receives the signals transmitted from the first to fourth LF transmission antennas 14a, 14b, 14c, and 14d, and transmits a response signal corresponding to the received signals, to the on-board device 1, using radio waves in the UHF band. The on-board device 1 receives the response signal transmitted from the portable device 5, using the RF reception antennas 13a and 13b. Upon successfully authenticating the portable device 5 through wireless communication with the portable device 5, the on-board device 1 turns on the external vehicle illumination units 6. The external vehicle illumination units 6 thus turned on brightly illuminate an area around the vehicle C to welcome the user.

Note that the LF band and the UHF band employed in the vehicle communication system according to the present embodiment are examples of radio wave bands that are used to perform wireless communication, and other radio wave bands may be employed.

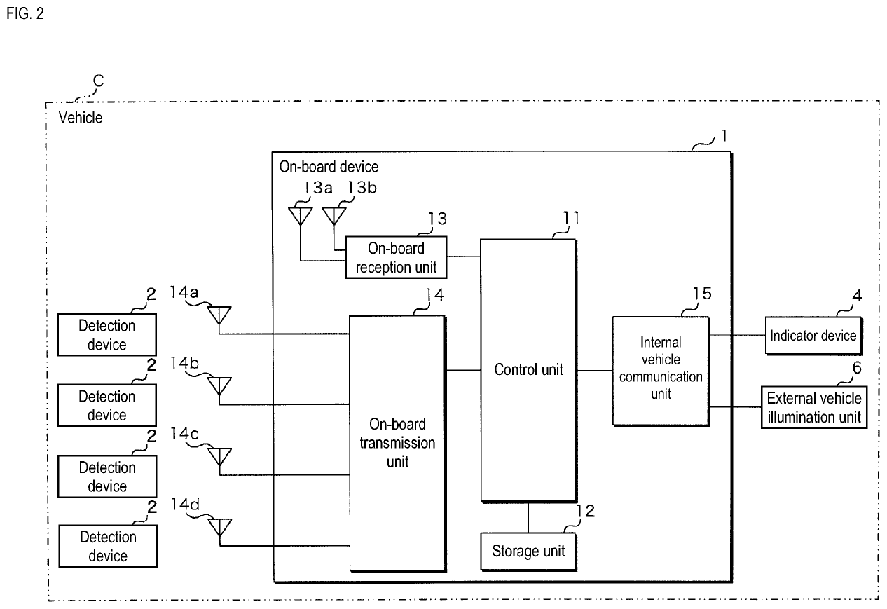

FIG. 2 is a block diagram showing an example of a configuration of the on-board device 1. The on-board device 1 includes a control unit 11 that controls operations of each constituent unit of the on-board device 1. A storage unit 12, an on-board reception unit 13, an on-board transmission unit 14, and an internal vehicle communication unit 15 are connected to the control unit 11.

The control unit 11 includes, for example, a CPU (Central Processing Unit), a ROM (Read Only Memory), a RAM (Random Access Memory), an input/output interface, and so on. The CPU of the control unit 11 is connected to the storage unit 12, the on-board reception unit 13, the on-board transmission unit 14, and the internal vehicle communication unit 15 via the input/output interface. The control unit 11 executes a control program that is stored in the storage unit 12, to control operations of each constituent unit and execute processing related to the function of detecting the position of the portable device 5, the welcome light function, and the tire air pressure monitoring function.

Note that the control unit 11 is not limited to the above-described configuration, and may be realized as one or more processing circuits that include a single core CPU, a multicore CPU, a microcomputer, a volatile or non-volatile memory, and so on. Also, the control unit 11 may be provided with the functions of a clock that measures time, a timer that measures a period of time that elapses from when a measurement start instruction is provided to when a measurement end instruction is provided, a counter that counts numbers, and so on.

The storage unit 12 is a non-volatile memory such as an EEPROM (Electrically Erasable Programmable ROM) or a flash memory. The storage unit 12 stores a control program that enables the control unit 11 to control operations of each constituent component of the on-board device 1 to realize the welcome light function and the tire pressure monitoring function.

A plurality of RF reception antennas 13a and 13b that are separately located on the vehicle C are connected to the on-board reception unit 13. The on-board reception unit 13 receives signals transmitted from the portable device 5 or the detection devices 2 using radio waves in an RF band, via the RF reception antennas 13a and 13b. The on-board reception unit 13 is a circuit that demodulates the signals thus received, and outputs the demodulated signals to the control unit 11. Although carrier waves in the UHF band from 300 MHz to 3 GHz are employed here, carrier waves in another frequency band may be employed. Although the present embodiment describes a mode in which two RF reception antennas 13a and 13b are connected to the on-board reception unit 13, three or more RF reception antennas may be mounted thereon.

The first to fourth LF transmission antennas 14a, 14b, 14c, and 14d are connected to the on-board transmission unit 14. Each of the first to fourth LF transmission antennas 14a, 14b, 14c, and 14d includes: a rod-shaped magnetic core that is made of ferrite; and a coil that is wound around the outer circumferential surface of the magnetic core. Capacitors are respectively connected to the coils so as to form resonant circuits. The resonant circuits are connected to the on-board transmission unit 14. The on-board transmission unit 14 is a circuit that modulates signals output from the control unit 11 into signals in the LF band, and substantially simultaneously or individually transmits the modulated signals to the portable device 5 or the detection devices 2, from the first to fourth LF transmission antennas 14a, 14b, 14c, and 14d. The on-board transmission unit 14 feeds currents to the coils such that the transmission ranges of the signals transmitted from the first to fourth LF transmission antennas 14a, 14b, 14c, and 14d are included in a certain range around the vehicle, and thus signals are transmitted. The transmission ranges are ranges in which the portable device 5 can receive the signals. Although carrier waves in the LF band from 30 kHz to 300 kHz are used here, carrier waves in another frequency band may be employed.

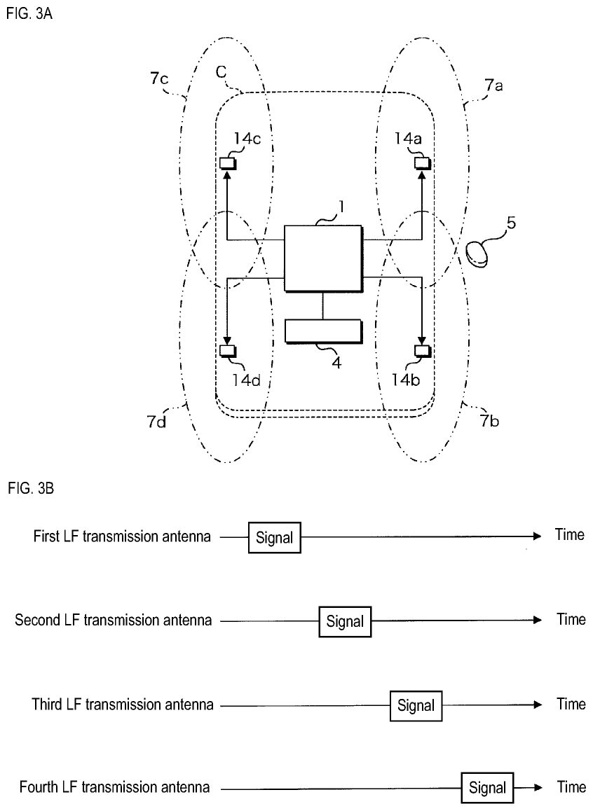

FIGS. 3A and 3B are diagrams illustrating transmission ranges in a case where signals are individually transmitted from the LF transmission antennas 14a, 14b, 14c, and 14d. FIG. 3A conceptually shows transmission ranges 7a, 7b, 7c, and 7d in a case where signals are individually transmitted from the first to fourth LF transmission antennas 14a, 14b, 14c, and 14d. FIG. 3B is a timing chart of signals that are transmitted from the first to fourth LF transmission antennas 14a, 14b, 14c, and 14d. The horizontal axis indicates time, and each “SIGNAL” enclosed in a square indicates the timing of transmitting the signal.

The transmission range 7a of a signal that is transmitted from the individual first LF transmission antenna 14a is limited to a predetermined range centered around the first LF transmission antenna 14a. Similarly, the transmission range 7b of a signal that is transmitted from the individual second LF transmission antenna 14b is limited to a predetermined range centered around the second LF transmission antenna 14b. Therefore, the signal strength at a midpoint in the front-rear direction of the vehicle C is weak, and the portable device 5 when located at the position shown in FIG. 3A cannot receive signals transmitted from the first and second LF transmission antennas 14a and 14b.

Similarly, the transmission ranges 7c and 7d of signals that are individually transmitted from the third and fourth LF transmission antennas 14c and 14d are respectively limited to predetermined ranges centered around the third and fourth LF transmission antennas 14c and 14d.

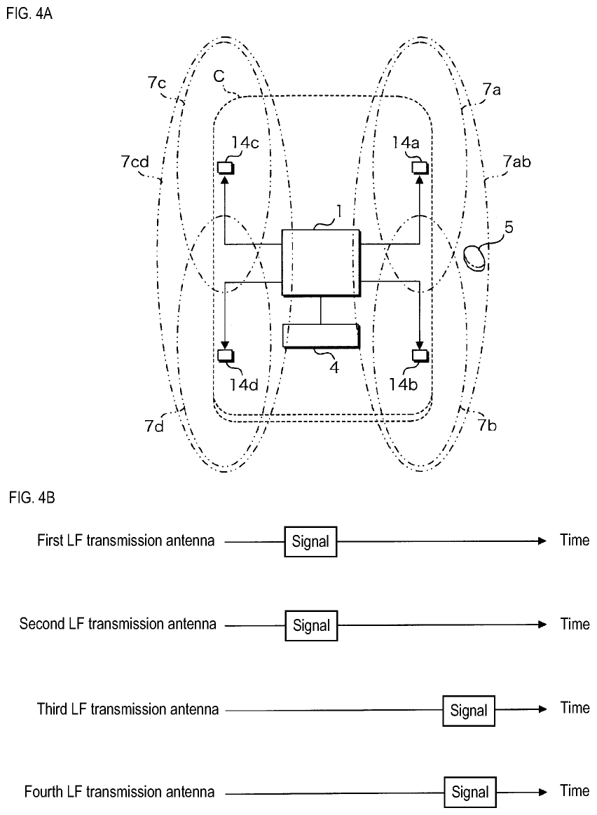

FIGS. 4A and 4B are diagrams illustrating transmission ranges in a case where signals are substantially simultaneously transmitted from two LF transmission antennas 14a and 14b (14c and 14d). FIG. 4A conceptually shows a transmission range 7ab in a case where signals are substantially simultaneously transmitted from the first and second LF transmission antennas 14a and 14b, and a transmission range 7cd in a case where signals are substantially simultaneously transmitted from the third and fourth LF transmission antennas 14c and 14d. FIG. 4B is a timing chart of signals that are transmitted from the first to fourth LF transmission antennas 14a, 14b, 14c, and 14d. The horizontal axis indicates time, and each “SIGNAL” enclosed in a square indicates the timing of transmitting the signal.

As shown in FIG. 4A, the transmission range 7ab of signals that are substantially simultaneously transmitted from the first and second LF transmission antennas 14a and 14b is larger than the transmission range 7a (7b) of signals that are transmitted from the individual first LF transmission antenna 14a (or the second LF transmission antenna 14b). Since the signals transmitted from the first and second LF transmission antennas 14a and 14b are in the LF band, the amplitudes of the signals around the vehicle C are uniform, and the signals respectively transmitted from the first and second LF transmission antennas 14a and 14b are superimposed on each other without interfering with or cancelling out each other, and thus the amplitudes are increased. Therefore, the portable device 5 located at the position shown in FIG. 4A, for example, can receive signals that are substantially simultaneously transmitted from the first and second LF transmission antennas 14a and 14b.

Similarly, the transmission range 7cd of signals that are substantially simultaneously transmitted from the third and fourth LF transmission antennas 14c and 14d is larger than the transmission range 7c (7d) of signals that are transmitted from the individual third LF transmission antenna 14c (or the fourth LF transmission antenna 14d). Since the signals transmitted from the third and fourth LF transmission antennas 14c and 14d are in the LF band, the amplitudes of the signals around the vehicle C are uniform, and the signals respectively transmitted from the third and fourth LF transmission antennas 14c and 14d are superimposed on each other without interfering with or cancelling out each other, and thus the amplitudes are increased.

In this way, if signals are substantially simultaneously transmitted from a plurality of LF transmission antennas, transmission ranges of signals can be expanded. On the other hand, due to signals being substantially simultaneously transmitted, it is impossible to determine which LF transmission antenna has transmitted a signal when a response signal has been obtained, and it is impossible to specify the position and the moving direction of the portable device 5. In the present embodiment, while the transmission ranges of signals that are transmitted from the on-board device 1 are expanded, the on-board device 1 estimates the direction of arrival of a signal based on the phase difference of the signal received by each of the plurality of RF reception antennas 13a and 13b to specify the position and the moving direction of the portable device 5. The direction-of-arrival estimation method will be described later.

Meanwhile, when transmitting wake-up signals to activate the detection devices 2 of the tires 3, or when transmitting air pressure information request signals to the detection devices 2, the on-board transmission unit 14 separately transmits the wake-up signals or the air pressure information request signals from the first to fourth LF transmission antennas 14a, 14b, 14c, and 14d.

The present embodiment mainly describes a case in which the signals that are substantially simultaneously transmitted from two or more transmission antennas among the first to fourth LF transmission antennas 14a, 14b, 14c, and 14d are the same signals. However, such a case is an example, and the signals are not necessarily exactly the same signals. Also, as long as the signals that are substantially simultaneously transmitted from two or more transmission antennas among the first to fourth LF transmission antennas 14a, 14b, 14c, and 14d are superimposed on each other and have a large amplitude, the signals may be out of phase. Furthermore, the signals transmitted from two or more transmission antennas among the first to fourth LF transmission antennas 14a, 14b, 14c, and 14d are not necessarily transmitted at exactly the same time, and the transmission timings of the signals may be different from each other as long as the signals are superimposed on each other and the amplitude thereof is large.

The internal vehicle communication unit 15 is a communication circuit that performs communication according to a communication protocol such as CAN (Controller Area Network) or LIN (Local Interconnect Network), and is connected to the indicator device 4 and the external vehicle illumination units 6. The internal vehicle communication unit 15 transmits air pressure information regarding the tires 3 to the indicator device 4, under the control of the control unit 11. Also, if the portable device 5 that is located in the vicinity of the vehicle C is detected, the internal vehicle communication unit 15 transmits lighting control signals to the external vehicle illumination units 6, under the control of the control unit 11.

The indicator device 4 is, for example, a display unit or an audio device provided with a speaker, which uses images or sounds to indicate air pressure information regarding the tires 3 transmitted from the internal vehicle communication unit 15, a display unit that is provided in an indicator on an instrument panel, or the like. The display unit is a liquid crystal display, an organic EL display, a head-up display, or the like. For example, the indicator device 4 displays air pressure information regarding the tires 3 provided for the vehicle C.

Each external vehicle illumination unit 6 includes, for example, a light source that is provided on a door mirror or a door of the vehicle C, a driving circuit that supplies power to the light source to turn on the light source, and a reception circuit, that receives a lighting control signal transmitted from the internal vehicle communication unit 15. The external vehicle illumination units 6 turn on the light sources upon receiving the lighting control signals transmitted from the internal vehicle communication unit 15. The external vehicle illumination units 6 thus turned on illuminate an area around the vehicle C.

In the present embodiment, the external vehicle illumination units 6 that illuminate the outside of the vehicle are described as examples of lights that realize the welcome light function. However, lights that illuminate the inside of the vehicle may be employed.

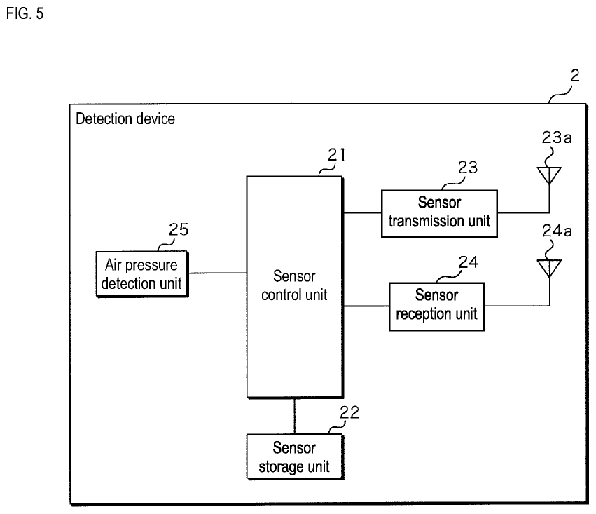

FIG. 5 is a block diagram showing an example of a configuration of a detection device 2. The detection device 2 includes a sensor control unit 21 that controls operations of each constituent unit of the detection device 2. A sensor storage unit 22, a sensor transmission unit 23, a sensor reception unit 24, and an air pressure detection unit 25 are connected to the sensor control unit 21.

The sensor control unit 21 includes, for example, a CPU, a ROM, a RAM, an input/output interface, and so on. The CPU of the sensor control unit 21 is connected to the sensor storage unit 22, the sensor transmission unit 23, the sensor reception unit 24, and the air pressure detection unit 25 via the input/output interface. The sensor control unit 21 reads out a control program that is stored in the sensor storage unit 22, and controls each unit. The detection device 2 is provided with a battery (not shown), and operates using power from the battery.

Note that the sensor control unit 21 is not limited to the above-described configuration, and may be realized as one or more processing circuits that include a single core CPU, a multicore CPU, a microcomputer, a volatile or non-volatile memory, and so on. Also, the sensor control unit 21 may be provided with the functions of a clock that measures time, a timer that measures a period of time that elapses from when a measurement start instruction is provided to when a measurement end instruction is provided, a counter that counts numbers, and so on.

The sensor storage unit 22 is a non-volatile memory. The sensor storage unit 22 stores a control program that is used by the sensor control unit 21 to perform processing related to detection of the air pressure in the tire 3 and transmission of an air pressure signal. The sensor storage unit 22 also stores a unique sensor identifier that is used to distinguish the detection device 2 to which the sensor storage unit 22 belongs from other detection devices 2.

The air pressure detection unit 25 is provided with a diaphragm, for example, and detects the air pressure in the tire 3 based on the amount of deformation of the diaphragm that changes depending on the level of pressure. The air pressure detection unit 25 outputs a signal that indicates the detected air pressure in the tire 3, to the sensor control unit 21. The sensor control unit 21 executes a control program to acquire the air pressure in the tire 3 from the air pressure detection unit 25, generates an air pressure signal that includes air pressure information, a sensor identifier that is unique to the detection device 2, and so on, and outputs the air pressure signal to the sensor transmission unit 23.

Note that a temperature detection unit (not shown) that detects the temperature of the tire 3 and outputs a signal that indicates the detected temperature to the sensor control unit 21 may be provided. If this is the case, the sensor control unit 21 generates an air pressure signal that includes air pressure information, temperature information, the sensor identifier, and so on, and outputs the air pressure signal to the sensor transmission unit 23.

An RF transmission antenna 23a is connected to the sensor transmission unit 23. The sensor transmission unit 23 modulates the air pressure signal generated by the sensor control unit 21 into a signal in the UHF band, and transmits the modulated air pressure signal, using the RF transmission antenna 23a.

An LF reception antenna 24a is connected to the sensor reception unit 24. The sensor reception unit 24 receives, from the LF reception antenna 24a, an air pressure information request signal transmitted from the on-board device 1 using radio waves in the LF band, and outputs the received air pressure information request signal to the sensor control unit 21.

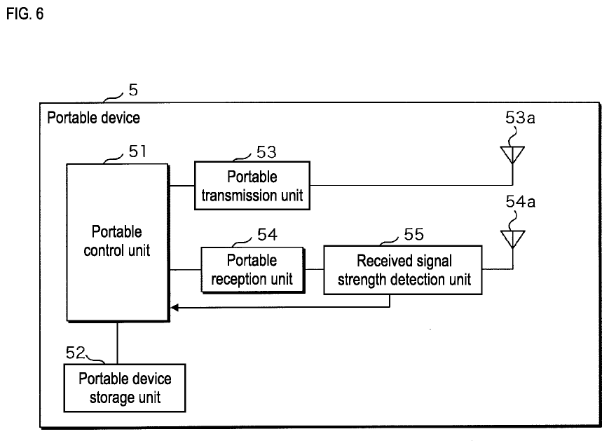

FIG. 6 is a block diagram showing an example of a configuration of the portable device 5. The portable device 5 includes a portable control unit 51 that controls operations of each constituent unit of the portable device 5. The portable control unit 51 is, for example, a microcomputer that includes at least one CPU, a multicore CPU, and so on. The portable control unit 51 is provided with a portable device storage unit 52, a portable transmission unit 53, and a portable reception unit 54. The portable device 5 is provided with a battery (not shown), and operates using power from the battery.

The portable control unit 51 reads out a control program described below, which is stored in the portable device storage unit 52, to control operations of each constituent unit. The portable control unit 51 has a dormant state in which power consumption is small and an active state in which power consumption is large. In a dormant state, upon the portable device 5 receiving a signal (e.g. a wake-up signal) transmitted from the on-board device 1, the portable control unit 51 transitions from the dormant state to an active state, and starts operating. In an active state, after the portable control unit 51 has finished the required processing, if a predetermined period of time elapses without the portable device 5 receiving a signal from the on-board device 1, the portable control unit 51 transitions to a dormant state again.

The portable device storage unit 52 is a non-volatile memory that is similar to the storage unit 12. The portable device storage unit 52 stores a control program that enables the portable control unit 51 to control operations of each constituent unit of the portable device 5 to execute processing to check that an authorized portable device 5 is located in the vicinity of the vehicle C.

The portable transmission unit 53 is connected to an RF transmission antenna 53a, and transmits a response signal corresponding to a signal transmitted from the on-board device 1, under the control of the portable control unit 51. The portable transmission unit 53 transmits a response signal using radio waves in the UHF band. Note that the UHF band is an example of a radio wave band that is employed to transmit a signal, and another radio wave band may be employed.

The portable reception unit 54 is connected to an LF reception antenna 54a via a received signal strength detection unit 55. The portable reception unit 54 receives various kinds of signals transmitted from the on-board device 1 using radio waves in the LF band, and outputs the signals to the portable control unit 51. The LF reception antenna 54a is a three-axis antenna, for example, and is able to obtain received signal strength at a certain level regardless of the direction or the orientation of the portable device 5 relative to the vehicle C.

The received signal strength detection unit 55 is a circuit that detects the received signal strength of a signal received by the LF reception antenna 54a, especially, the received signal strength of a detection signal that is used to detect the position of the portable device 5, and outputs the received signal strength thus detected, to the portable control unit 51. The received signal strength may also be used to detect the position of the portable device 5 relative to the vehicle C.

The following describes a method according to the present embodiment in which the on-board device 1 detects the portable device 5.

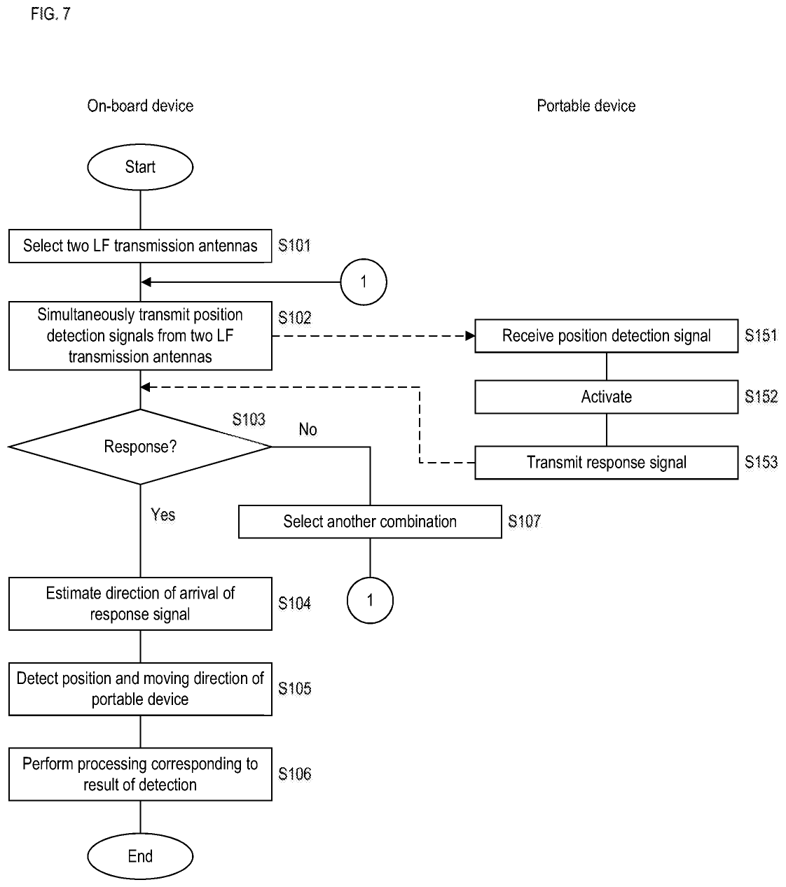

FIG. 7 is a flowchart showing processing procedures that are performed by the on-board device 1 and the portable device 5. The control unit 11 of the on-board device 1 performs the following processing at an appropriate point in time when an ignition switch of the vehicle C is in an off state and after the door is locked, for example. The control unit 11 selects two LF transmission antennas from among the first to fourth LF transmission antennas 14a, 14b, 14c, and 14d mounted on the vehicle C (step S101), and controls the on-board transmission unit 14 to substantially simultaneously transmit position detection signals from the two selected LF transmission antennas (step S102). For example, the control unit 11 selects the first and second LF transmission antennas 14a and 14b as a first combination, and substantially simultaneously transmits position detection signals from the first and second LF transmission antennas 14a and 14b thus selected.

The portable device 5 monitors for signals transmitted from the outside thereof, even in a dormant state, and upon a position detection signal being transmitted from the on-board device 1, the portable reception unit 54 receives the position detection signal (step S151). The portable control unit 51 of the portable device 5 that has received the position detection signal transitions from a dormant state to an active state (step S152), and then transmits a response signal that includes the identifier of the portable device 5 to the on-board device 1 using the portable transmission unit 53 (step S153).

The control unit 11 of the on-board device 1 that has transmitted the position detection signal through processing in step S102 determines whether or not a response signal transmitted from the portable device 5 has been received by two RF reception antennas 13a and 13b within a predetermined waiting period (step S103).

Upon determining that a response signal has been received (S103: YES), the control unit 11 estimates the direction of arrival of the response signal based on the phase difference of the response signal received by the two RF reception antennas 13a and 13b (step S104). A well-known method such as the beamformer method, the Capon method, the linear prediction method, the minimum norm method, the MUSIC method (MUSIC: Multiple Signal Classification), the ESPRIT method (Estimation of Signal Parameters via Rotational Invariance Techniques), or the like may be employed as the method for estimating the direction of arrival of the response signal.

The following describes a direction-of-arrival estimation method that employs the MUSIC method for example. First, an array antenna with K elements is conceived of, where K is an integer no less than 2. When λ denotes the wavelength of arrival waves, L denotes the number of arrival waves, and θᵢ (i=1, . . . , L) denotes the arrival angle of the i^{th} arrival wave, the array response vector a(θᵢ) corresponding to the i^{th} arrival wave is given by the following expression.

a(θᵢ)=[exp{jΨ₁(θᵢ)}, . . . , exp{jΨ_{K}(θᵢ)}]^{T}

Here, Ψₙ(θᵢ)=−(2π/λ)dₙ sin(θᵢ) is satisfied, which expresses the phase of the i^{th} wave received by the n^{th} array element. Note that dₙ denotes the distance from a reference point to the element corresponding thereto.

Here, an autocorrelation matrix R is given by the following expression.

R=E[x(t)x^{H}(t)]

Here, x(t) denotes a K-dimensional reception signal vector consisting of signals received by the n^{th} element (1≤n≤K), and R denotes a K×K matrix. E[ . . . ] denotes an ensemble mean, and x^{H}(t) denotes complex conjugate transpose of x(t).

The autocorrelation matrix R is eigenexpanded to obtain an eigenvector eᵢ (1≤i≤L) corresponding to a very small eigenvalue. L denotes the dimension of the noise subspace, and can be estimated using a dimension estimation method such as the AIC (Akaike Information Criteria).

When a(θ) denotes the array response vector of the arrival angle θ and θ matches the arrival angle of the incident wave, a(θ) is orthogonal to the noise subspace, and therefore eᵢ^{H}a (θ)=0(1≤i≤L) is satisfied. From this equation, the MUSIC spectrum P_{MU}(θ) can be defined as follows.

P_{MU}(θ)=a^{H}(θ)a(θ)/(Σ|eᵢ^{H}a(θ)|²)

When θ matches the arrival angle θᵢ (1≤i≤L) of the incident wave, the MUSIC spectrum P_{MU}(θ) has L sharp peaks. In the present embodiment, reception signals received by the two RF reception antennas 13a and 13b are input from the on-board reception unit 13 to the control unit 11. For example, the control unit 11 can estimate the arrival angle θi (i=1, . . . , L) of the received response signal by fixing the phase of one reception signal of the two reception signals input from the on-board reception unit 13, and searching for the phase of the other reception signal such that the MUSIC spectrum P_{MU}(θ) has a peak.

Although the present embodiment describes procedures in which the MUSIC method is employed to estimate the arrival angle (the direction of arrival) of a response signal, for example, any of the aforementioned methods such as the beamformer method, the Capon method, the linear prediction method, the minimum norm method, or the ESPRIT method may be employed to estimate the direction of arrival of a response signal.

The control unit 11 of the on-board device 1 detects the position and the moving direction of the portable device 5 based on the direction of arrival of the response signal estimated in step S104 (step S105). In the present embodiment, there is no need to detect the exact position of the portable device 5, and it is possible to employ a configuration for detecting positions that are distinguishable from each other, such as a front position, a side position, and a rear position relative to the vehicle C.

Upon detecting the position and the moving direction of the portable device 5, the control unit 11 of the on-board device 1 performs processing corresponding to the result of detection (step S106). For example, the control unit 11 may perform processing to turn on an external vehicle lighting unit 6 corresponding to the detected position by transmitting a lighting control signal to the external vehicle lighting unit 6. Also, the control unit 11 may perform processing to push up a door handle located at a position corresponding to the detected position by transmitting a control signal to a drive control unit (not shown) for pushing up the door handle.

In step S103, if a response signal from the portable device 5 has not been received within the predetermined waiting period (S103: NO), the control unit 11 selects another combination of LF transmission antennas (e.g. the third and fourth LF transmission antennas 14b and 14c) from which a position detection signal is to be transmitted (step S107), and returns processing to step S102 to continue the processing for detecting the position of the portable device 5

With the on-board device 1 and the vehicle communication system that are configured as described above, it is possible to expand the transmission ranges of signals by substantially simultaneously transmitting signals from two LF transmission antennas. Also, the on-board device 1 can estimate the direction of arrival of a response signal in the transmission ranges based on the phase difference of the response signal received using the two RF reception antennas 13a and 13b, and can estimate the position and the moving direction of the portable device 5.

The present embodiment describes a configuration in which the welcome light function is realized using the first to fourth LF transmission antennas 14a, 14b, 14c, and 14d that constitute the tire pressure monitoring system. However, as a matter of course, the welcome light function may be realized using LF transmission antennas that constitute Smart Entry (registered trademark) or any other system.

In addition, although the present embodiment describes an example in which the same signals are substantially simultaneously transmitted from a combination of two LF transmission antennas, it is of course possible to employ a configuration in which the same signals are substantially simultaneously transmitted from a combination of three or more LF transmission antennas.

Furthermore, although the present embodiment describes a configuration in which the LF transmission antennas are located at the tire positions, the positions of the LF transmission antennas are not limited to the tire positions. For example, it is possible to employ a configuration in which an LF transmission antenna is located on a rear portion of the vehicle, or a configuration in which LF transmission antennas are located on a right side surface, a left side surface, a rear portion, and so on of the vehicle, in addition to the tire positions.

Furthermore, the present disclosure is not only applicable to a system that realizes a welcome light function, but also applicable to Walk Away Close function, Smart Entry (registered trademark) function, and any other systems that require communication with the portable device 5.

Moreover, although the present embodiment describes an example in which the on-board device 1 transmits signals using radio waves in the LF band, the frequencies of signals are not particularly limited as long as signals transmitted from two LF transmission antennas interfere with or cancel out each other in the range where the on-board device 1 is required to communicate with the portable device 5.

### Second Embodiment

The second embodiment describes a configuration for controlling the phases of signals that are substantially simultaneously transmitted from two LF transmission antennas.

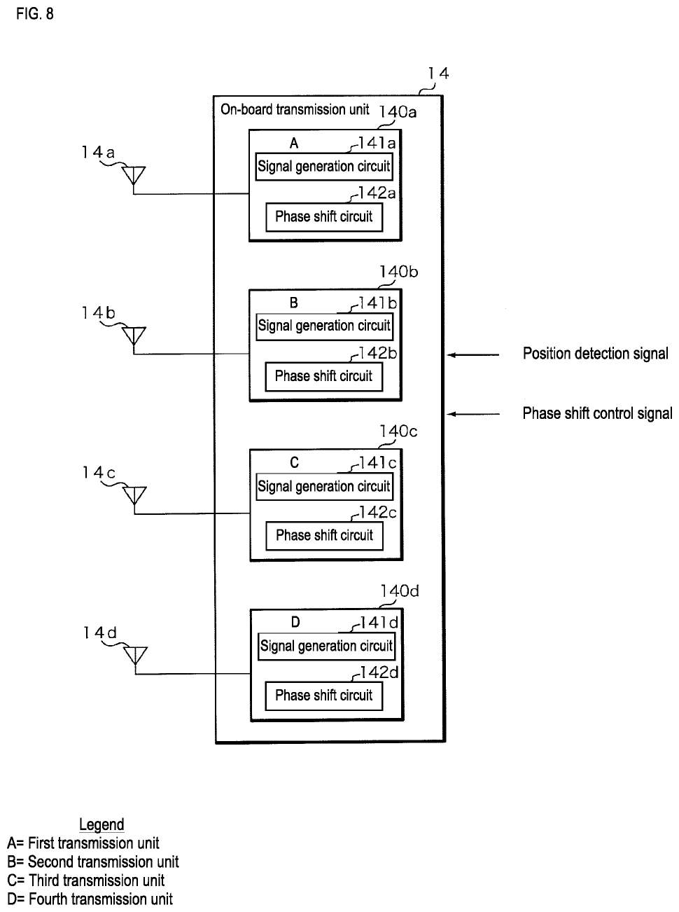

FIG. 8 is a block diagram illustrating an example of a configuration of an on-board transmission unit 14 according to a second embodiment. The on-board transmission unit 14 includes first to fourth transmission units 140a, 140b, 140c, and 140d that respectively generate signals in the LF band that are to be transmitted from the first to fourth LF transmission antennas 14a, 14b, 14c, and 14d. In the second embodiment, each of the first to fourth LF transmission antennas 14a, 14b, 14c, and 14d includes: a rod-shaped magnetic core that is made of ferrite; and a coil that is wound around the magnetic core, and the coils are wound around the magnetic cores in the same direction.

The first transmission unit 140a includes a signal generation circuit 141a and a phase shift circuit 142a. The signal generation circuit 141a superimposes the signal wave of a signal (e.g. a position detection signal) input from the control unit 11 onto a carrier wave (a carrier) to modulate the signal into a signal in the LF band. Note that the carrier wave is generated by an RC oscillation circuit, a crystal oscillation circuit, or the like (not shown). The signal wave modulated by the signal generation circuit 141a (the modulated wave) is input to the phase shift circuit 142a. The phase shift circuit 142a controls the phase of the input signal wave (modulated wave) based on a phase shift control signal that is input from the control unit 11, for example. The first transmission unit 140a transmits the signal wave, which has been subjected to phase control performed by the phase shift circuit 142a, to the outside via the first LF transmission antenna 14a.

The configurations of the second to fourth transmission units 140b, 140c, and 140d are the same as the configuration of the first transmission unit 140a. That is, the second transmission unit 140b includes a signal generation circuit 141b and a phase shift circuit 142b, the third transmission unit 140c includes a signal generation circuit 141c and a phase shift circuit 142c, and the fourth transmission unit 140d includes a signal generation circuit 141d and a phase shift circuit 142d. Each of the second to fourth transmission units 140b, 140c, and 140d superimposes the signal wave of a signal (e.g. a position detection signal) input from the control unit 11 onto a carrier wave to modulate the signal into a signal in the LF band, thereafter controls the phase based on a phase shift control signal that is input from the control unit 11, and transmits the signal wave, which has been subjected to phase control, to the outside via the second to fourth LF transmission antennas 14b, 14c, and 14d.

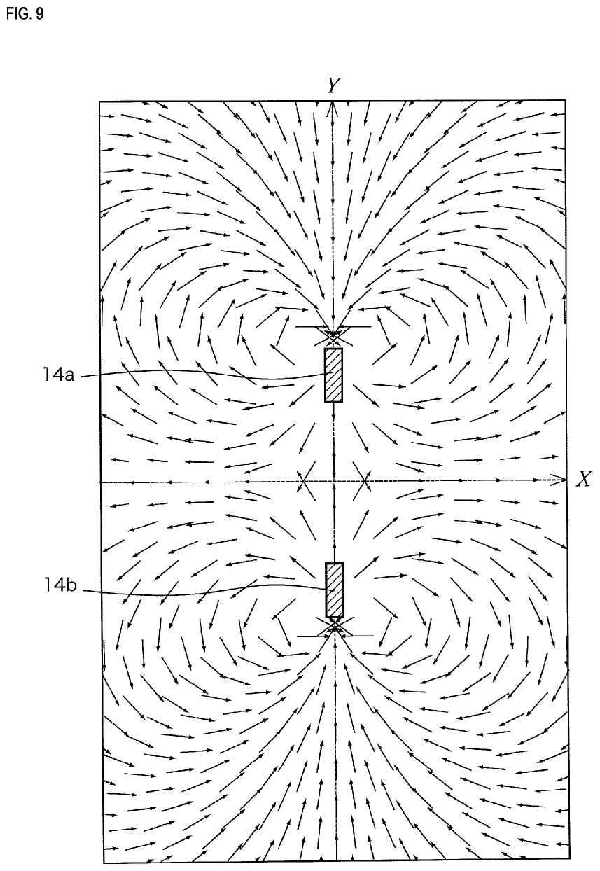

FIG. 9 is a distribution diagram showing an example of a magnetic field distribution of signal waves that are transmitted from LF transmission antennas. The example in FIG. 9 shows the direction of the magnetic field generated when signals in antiphase are transmitted substantially simultaneously from the first and second LF transmission antennas 14a and 14b. In the distribution diagram shown in FIG. 9, the X axis extends in the direction that matches the left-right direction of the vehicle C, and the Y axis extends in the direction that matches the front-rear direction of the vehicle C. The first and second LF transmission antennas 14a and 14b are both located on the Y axis, at the same distance from the X axis (e.g. at 1.2 m from the X axis). The axial direction of the magnetic cores of the first and second LF transmission antennas 14a and 14b is parallel with the Y axis, and the winding directions of the coils wound around the magnetic cores are the same.

If the signal waves in antiphase are transmitted from the first and second LF transmission antennas 14a and 14b, the directions of the magnetic fields of the signal waves respectively transmitted therefrom are opposite to each other in the vicinity of the Y axis. As a result, as can be seen, the signal strength in the vicinity of the Y axis (especially, at a midpoint between the first and second LF transmission antennas 14a and 14b) is smaller than when one of the LF transmission antennas is individually driven.

In contrast, in an area that is away from the Y axis, each of the magnetic fields of the signal waves transmitted from the first and second LF transmission antennas 14a and 14b has a component that is orientated in the X axis direction. If the signal waves in antiphase are transmitted from the first and second LF transmission antennas 14a and 14b, the directions of the magnetic fields of the signal respectively transmitted therefrom are substantially the same in the vicinity of the X axis. As a result, as can be seen, the signal strength in an area that is away from the Y axis and is in the vicinity of the X axis (e.g. at a position near the portable device 5 shown in FIG. 4A) is greater than when one of the LF transmission antennas is individually driven.

If the output level of the first and second LF transmission antennas 14a and 14b is not high, the strength of the magnetic field is small at a position away from them, and therefore the influence of one magnetic field on another magnetic field is small. Therefore, the strength of the magnetic field at a position that is forward of the first LF transmission antenna 14a and the strength of the magnetic field at a position that is rearward of the second LF transmission antenna 14b are similar to the strength of the magnetic field when each antenna is individually driven.

As described in the first embodiment, the transmission range 7a of a signal when the first LF transmission antenna 14a is used alone is limited to a predetermined range that is centered around the first LF transmission antenna 14a. Similarly, the transmission range 7b when the second LF transmission antenna 14b is used alone is limited to a predetermined range that is centered around the second LF transmission antenna 14b.

In contrast, if signal waves in antiphase are substantially simultaneously transmitted from the first LF transmission antenna 14a and the second LF transmission antenna 14b, the signal waves transmitted therefrom are superimposed on each other in the vicinity of the X axis away from the Y axis, and the transmission range lab that is determined by the combined magnetic fields expands in the left-right direction around a central portion of the vehicle C in the front-rear direction.

Although not shown in the figures, the same applies to the case in which signal waves that are in antiphase are substantially simultaneously transmitted from the third and fourth LF transmission antennas 14c and 14d, and the transmission range of signal waves can be expanded in the left-right direction around a central portion of the vehicle C in the front-rear direction.

As described above, in the second embodiment, the transmission range of signal waves can be expanded in the left-right direction around a central portion of the vehicle C in the front-rear direction. Using such a configuration, by expanding the transmission range of position detection signals that are used to detect the portable device 5, for example, it is possible to more swiftly detect the portable device 5 approaching the vehicle C sideways.

The second embodiment employs a configuration in which the coils that constitute the first to fourth LF transmission antennas 14a, 14b, 14c, and 14d are wound in the same direction, and therefore the transmission range is expanded by transmitting signal waves that are in antiphase. However, if the coils that constitute the first and second LF transmission antennas 14a and 14b are wound in opposite directions, it is possible to employ a configuration in which the transmission range is expanded by transmitting signal waves that are in phase, from the first and second LF transmission antennas 14a and 14b.

Also, although the second embodiment describes a configuration for controlling the phases of the first and second LF transmission antennas 14a and 14b (the third and fourth LF transmission antennas 14c and 14d) that are arranged in the front-rear direction, it is possible to employ a configuration for controlling the phases of the first and third LF transmission antennas 14a and 14c (the second and fourth LF transmission antennas 14b and 14d) that are arranged in the left-right direction.

The embodiments disclosed herein are examples in all respects, and are not to be construed as limiting. The scope of the present disclosure is defined by the claims rather than by the meaning of the description above, and all modifications equivalent to and within the scope of the claims are intended to be encompassed.

1. An on-board device that transmits signals from a plurality of transmission antennas that are provided for a vehicle at positions that are separate from each other, and performs processing corresponding to a response signal from a portable device that has received the signals, the on-board device comprising:
a reception unit that receives the response signal via a plurality of reception antennas that are provided for the vehicle at positions that are separate from each other; and
an estimation unit that estimates a direction of arrival of the response signal based on a phase difference of the response signal received via the plurality of reception antennas.

2. The on-board device according to claim 1, further comprising:
a transmission control unit that changes a combination of a plurality of transmission antennas that transmit signals, if a response signal is not received from the portable device in response to the signals transmitted from the plurality of transmission antennas.

3. The on-board device according to claim 1, wherein signals in an LF (Low Frequency) band are transmitted from the plurality of transmission antennas.

4. The on-board device according to claim 1,
wherein at least two transmission antennas of the plurality of transmission antennas are located at positions that are separate from each other in a front-rear direction or a left-right direction relative to a travelling direction of the vehicle, and
the signals are substantially simultaneously transmitted from the two transmission antennas located at the positions that are separate from each other in the front-rear direction or the left-right direction.

5. The on-board device according to claim 4, further comprising:
a phase control unit that controls phases of the signals that are substantially simultaneously transmitted from the two transmission antennas.

6. The on-board device according to claim 1, wherein a signal for activating the portable device is transmitted via the plurality of transmission antennas.

7. The on-board device according to claim 1,
wherein the plurality of transmission antennas are respectively located at tire positions at which a plurality of tires of the vehicle are provided, and
signals are transmitted from the transmission antennas provided at the tire positions, to a plurality of detection devices that are respectively provided for the plurality of tires and wirelessly transmit air pressure signals obtained by detecting air pressures of the tires.

8. A vehicle communication system comprising:
the on-board device according to claim 1;
a plurality of transmission antennas that are provided for a vehicle at positions that are separate from each other;
a portable device that receives the signals transmitted from the on-board device, and transmits a response signal corresponding to the signals thus received; and
a plurality of reception antennas that are provided for the vehicle at positions that are separate from each other, and individually receive the response signal from the portable device.

9. A direction-of-arrival estimation method for estimating a direction of arrival of a response signal based on the response signal, the response signal being transmitted from a portable device that has received signals transmitted from a plurality of transmission antennas provided for a vehicle at positions separate from each other, the direction-of-arrival estimation method comprising:
receiving the response signal via a plurality of reception antennas that are provided for the vehicle at positions that are separate from each other; and
estimating the direction of arrival of the response signal based on a phase difference of the response signal received via the plurality of reception antennas.
